(19) United States
(12) Patent Application Publication
(10) Pub. No.: US 2004/0015110 A1
(43) Pub. Date: Jan. 22, 2004

(54) Massaging device

(76) Inventor: Kuo-Chin Chen, Taipei (TW)

Correspondence Address: PRO-TECHTOR INTERNATIONAL, 20775 Norada Court, Saratoga, CA, 95070-3018, US

(21) Appl. No.: 10/199,370

(22) Filed: Jul. 18, 2002

(51) Int. Cl. A61H 15/00

(52) U.S. Cl. 601/149

(57) ABSTRACT

A massaging device includes a handle and the rollers at the two corners of two ends of the handle; at least the two rollers of one end are not parallel and slant downward. When the massaging device is moved to and fro on skin to massage muscles and stimulate meridian points, the two non-parallel rollers squeezes muscles located between them and push fats under skin to help a user in body fitness.

### BACKGROUND OF THE INVENTION

1. Field of the Invention

The present invention relates to a massaging device, and more particularly to a massaging device that includes two anterior rollers and two posterior rollers capable of massaging muscles and squeezing and pushing fats under skin to achieve an effect of body fitness.

2. Description of the prior art

The commercially available manual type massaging devices are used to massage muscles and stimulate meridian points. The structure of the prior massage devices includes a handle and one or more pairs of rotatable rollers symmetrically and parallelly connected to two corners of the handle. By gripping at the handle, a user may apply proper downward force while moves the massaging device to and fro on skin, so that the one or more pairs of parallel rollers massage muscles and stimulate meridian points on the skin. Using the massaging device with parallel rollers, if the strength is too weak, the rollers only can glide on the skin lightly and cannot press the muscles. If the strength is too strong, it is easily to injure the muscle. Even if the user can use the massaging device on uniform force, the parallel rollers only can glide on the skin. The effect is just like massaging effect by using hands. Besides, it also cannot have effect of releasing muscles and fat-removing.

It is therefore tried by the inventor to develop a roller-type massaging device that has anterior rollers and the posterior rollers'symmetrically and parallelly connected to two sides of the handle. This massage device has the functions provided by fat-removing and massaging muscles.

### SUMMARY OF THE INVENTION

A primary object of the present invention is to provide a massaging device that massages muscles and meridian points while squeeze, pushes muscles and extra fats to achieve the effect to body fitness.

To achieve the above and other objects, the massaging device of the present invention mainly includes a handle and four rollers rotatably connected to two symmetrical bevels formed at two front side and two back side corners of the handle, so that the two rollers of one end are getting closes to each other either at a front or rear end instead of being in parallel with each other. Whereby when the massaging device is moved to and fro on skin to massage muscles and stimulate meridian points, the two non-parallel rollers squeeze muscles located between them and push fats under skin to help a user in body fitness.

### BRIEF DESCRIPTION OF THE DRAWINGS

The structure and technical means adopted by the present invention achieve the above and the objects can be best understood by referring to the following detailed description of the preferred embodiments and the accompanying drawings, wherein

FIG. 1 is an exploded perspective of the present invention;

FIG. 2 is an assembled perspective of the present invention;

FIG. 3 is a fragmentary plan view showing the present invention in use;

FIG. 4 is the bottom view 1 of the rollers arrangement of the present invention;

FIG. 5 is the bottom view 2 of the rollers arrangement of the present invention;

FIG. 6 is the bottom view 3 of the rollers arrangement of the present invention;

FIG. 7 is the bottom view 4 of the rollers arrangement of the present invention;

FIG. 8 is the bottom view 5 of the rollers arrangement of the present invention;

### DETAILED DESCRIPTION OF THE PREFERRED EMBODIMENTS

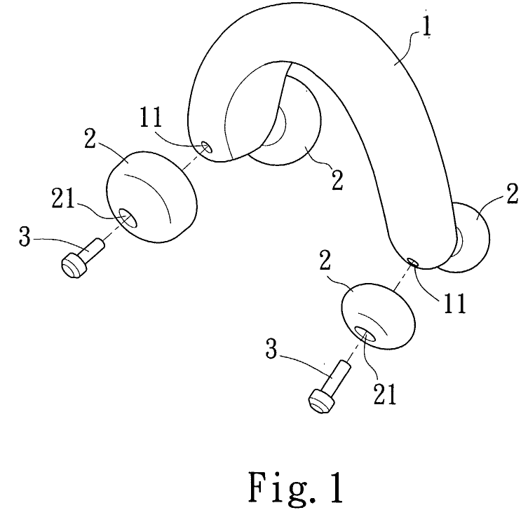

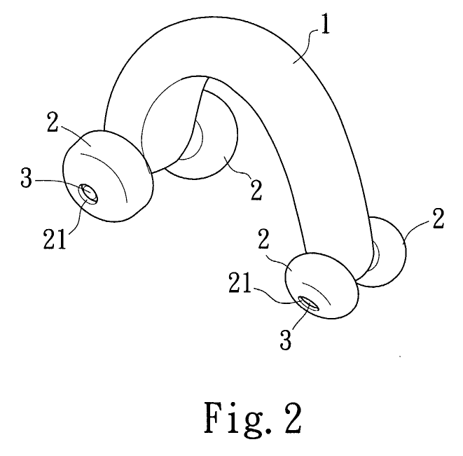

Please refer to FIGS. 1 and 2 that are exploded and assembled perspective views, respectively, of the present invention. As shown, the massaging device mainly includes a handle 1 and four rollers 2 connected to two front and back corners of the handle 1. The handle 1 is a curved cylinder. One end of the handle 1 is board and flat. Besides, the bevel-cambered planes of two sides of two ends intersect at a position in the end of the handle 1. Each of the bevel-cambered planes is provided with a hole 11 for a narrowed stem portion of a shaft 3 to insert thereinto. Each of the rollers 2 is provided with a stepped hole 21 aligned with a central axis of the roller 2, and each of the shafts 3 has an expanded head portion corresponding to the stepped hole 21. By extending the shaft 3 through the stepped hole 21 of one roller and into the hole 12 on the bevel-cambered planes, the roller 2 is connected to the handle 1 and restricted between the bevel-cambered planes and the expanded head portion of the shaft 3. The barrowed stem portions of the shaft 3 allow the rollers 2 to freely rotate about the shaft 3 at two sides of the handle 1.

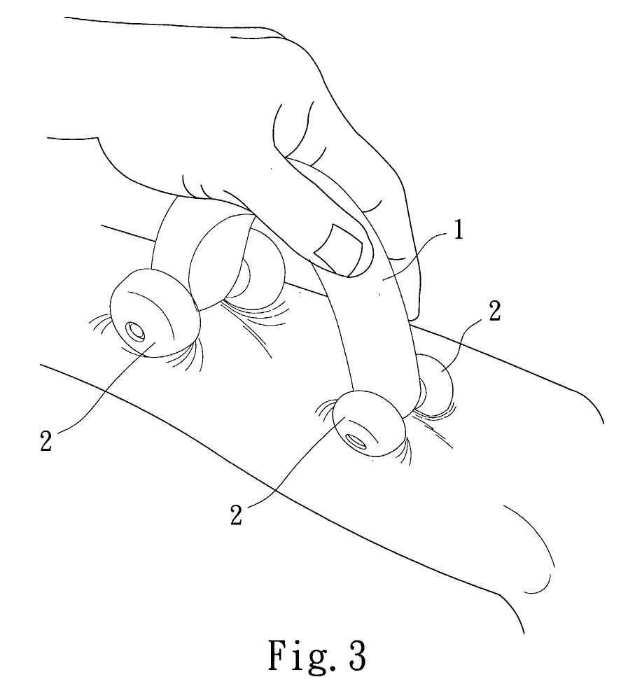

With the above arrangements, the top rollers 2 at the two corners of the handle 1 are not in parallel with one another. Thus, when the massaging device is used to massage a certain area of muscles, as shown in FIG. 3, a user may use handle 1 to move the massaging device to and fro while applying a downward force to press the rollers 2 against the muscles to stimulate meridian points thereat. Since the two rollers 2 are not in parallel with each other, muscles located between the two rollers 2 are squeezed into a bump when the rollers 2 could keep rotating. The rotating rollers 2 press and squeeze muscles and thereby push fats under skin to help the user in body fitness.

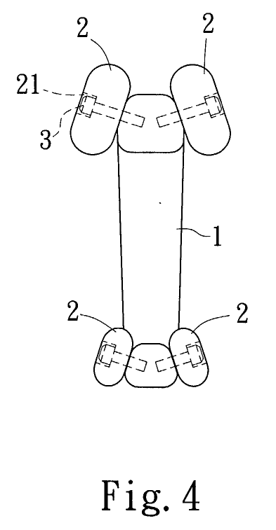

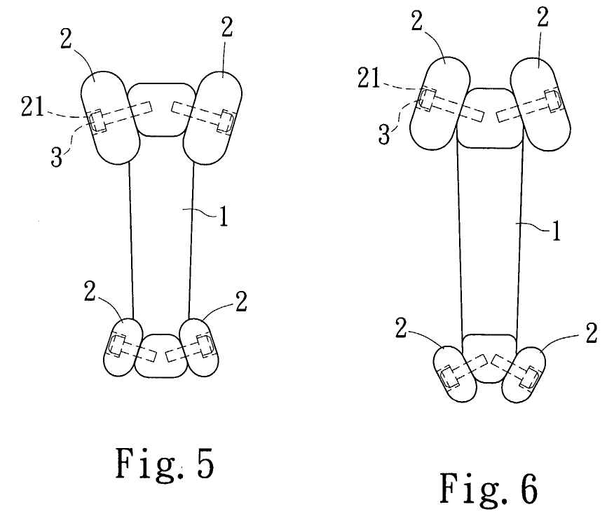

In other words, the effects that provided with fat-moving and lose weight doesn't limit to the arrangement of two rollers 2, which have ends facing inward to contain an angle between them. Please refer to FIGS. 4, 5 and 6. As shown, the rollers 2 at two sides of two ends of the handle 1 intersect at the outside of the handle 1 in two ways, one is inward and another is outward. Moreover, it also can all intersect inward or outward.

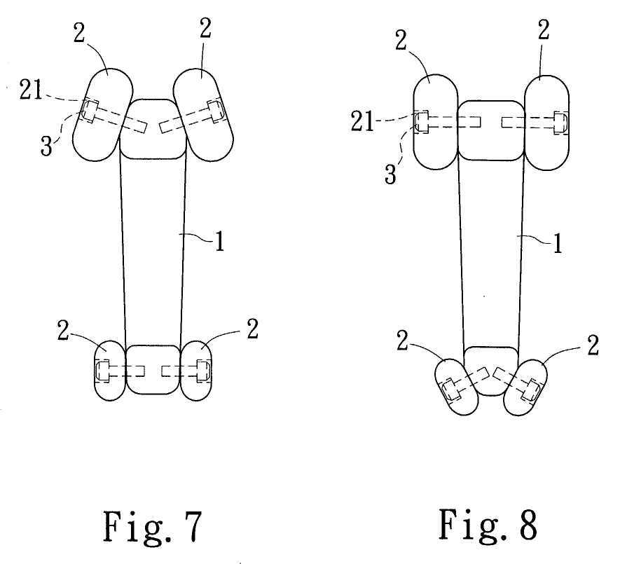

Please refer to FIG. 7. As shown, two rollers at two corners of one end of the handle 1 are not in parallel with each other and the extending of the bevel-cambered planes intersect at a position outside of the handle 1 with an outward angle. Besides, two rollers at two corners of the other end of the handle 1 are in parallel with each other.

Please refer to FIG. 8. As shown, two rollers at two corners of one end of the handle 1 are not in parallel with each other and the extending of the bevel-cambered planes intersect at a position outside of the handle 1 with an inward angle. Besides, two rollers at two corners of the other end of the handle 1 are in parallel with each other.

With the above arrangements, the rollers 2 at the front and back corners of the handle 1 are not in parallel with one another but have their rear ends facing inward and outward to contain an angle between them. Thus, when the massaging device is used to massage a certain area of muscles, as shown in FIG. 3, a user may grip at the handle 1 to move the massaging device to and fro while applying a downward force to press the rollers 2 against the muscles to stimulate meridian points thereat. Since the two rollers 2 are not in parallel with each other, muscles located between the two rollers 2 are squeezed into a bump when the rollers 2 keep rotating. The rotating rollers 2 could press and squeeze muscles and thereby push fats under skin to help the user in body fitness.

What is claimed is:

1. A massaging device comprising a handle and four rollers connected to two front side and two back side corners of said handle;
said massaging device being characterized in that said two rollers connected to two or two front and two back corners being so arranged that they are in a non-parallel relationship with each other, whereby when said massaging device is moved to and fro on skin to massage muscles and stimulate meridian points, said two non-parallel rollers squeeze muscles located between them and push fats under skin to help a user in body fitness.

2. The massaging device as claimed in claim 1, wherein said handle is a curved cylinder and one end of said handle is board and flat.

3. The massaging device as claimed in claim 1, wherein said two rollers of two ends are in non-parallel and two corners of two ends are symmetrically bevel-cambered planes that intersect at a position in the end of said handle and said rollers being rotatably connected to said bevel-cambered planes by separately inserting two shafts through said rollers and into said bevel-cambered planes, so that said shafts are perpendicular.

4. The massaging device as claimed in claim 1, wherein said two rollers of two ends are in non-parallel and said two rollers at two corners by the extending of the bevel-cambered planes intersect into a outward angle and a inward angle.

5. The massaging device as claimed in claim 1, wherein said two rollers of two ends are in non-parallel and said two rollers at two corners by the extending of the bevel-cambered planes intersect into a outward angle.

6. The massaging device as claimed in claim 1, wherein said two rollers of two ends are in non-parallel and said two rollers at two corners by the extending of the bevel-cambered planes intersect into a inward angle.

7. The massaging device as claimed in claim 1, wherein said two rollers of one end are not parallel and said two rollers at two corners by the extending of the bevel-cambered planes intersect into a inward angle; and said two rollers of another end are in parallel.

8. The massaging device as claimed in claim 1, wherein said two rollers of one end are in non-parallel and said two rollers at two corners by the extending of the bevel-cambered planes intersect into a outward angle; and said two rollers of another end are in parallel.

9. The massaging device as claimed in claim 1, wherein said handle being installed two big rollers in one end and two small rollers in another end.
